(19) United States
(12) Patent Application Publication
(10) Pub. No.: US 2024/0225005 A1
(43) Pub. Date: Jul. 11, 2024

(54) A MEANS OF REPELLING PESTS AND A METHOD OF REPELLING PESTS

(71) Applicant: Dariusz WASIK, Minsk Mazowiecki (PL)

(72) Inventor: Dariusz WASIK, Minsk Mazowiecki (PL)

(21) Appl. No.: 18/571,758

(22) PCT Filed: Apr. 19, 2022
(86) PCT No.: PCT/PL2022/050023

§ 371 Date: Dec. 19, 2023

(30) Foreign Application Priority Data
Jun. 22, 2021 (PL) P.438225

(51) Int. Cl. A01N 59/06; A01P 17/00

(52) U.S. Cl. CPC A01N 59/06; A01P 17/00

(57) ABSTRACT

A means of repelling pests, in particular snails/slugs, moles, ants and mole crickets, which is a composition comprising calcium oxide, calcium hydroxide and calcium carbonate, the calcium oxide accounting for not less than 10% by weight of the composition, and a method of repelling pests using the repellent.

### FIELD OF THE INVENTION

The invention relates to a means of repelling pests, in particular snails/slugs, moles and ants, as well as a method of repelling pests.

### BACKGROUND ART

The state of the art reveals a large number of crop pest repellents. However, most of them also harm the crops themselves by contaminating the plants, while also affecting the health of organisms other than pests.

### DESCRIPTION

The above problems are solved by a pest repellent according to the invention and a method of repelling pests according to the invention. Additionally, the pest repellent also contributes to accelerating and improving crop growth.

The means of repelling pests, in particular snails/slugs, moles, ants and mole crickets, according to the invention, is characteristic in that it is a composition comprising calcium oxide, calcium hydroxide and calcium carbonate, the calcium oxide accounting for not less than 10% by weight of the composition.

Advantageously, the repellent is powdered.

Advantageously, the repellent has the form of granules.

Advantageously, the repellent has the form of an aqueous solution of the composition.

Furthermore, the invention relates to a means of repelling pests, in particular snails/slugs, moles and ants, characteristic in that such pest repellent according to the invention is spread on the ground surface in the amount of 60-120 g per square metre of ground surface.

Preferably, the ground surface should be sprinkled with water after the pest repellent has been spread.

The object of the invention is illustrated in the following embodiments.

The following presents an example embodiment of the means of repelling pests, in particular snails/slugs, moles, ants and mole crickets, according to the invention. Food waste is directed via a hopper to a buffer tank where it is mixed and homogenised. The homogenised mass is transported to a processing reactor, in which a very highly reactive quicklime reagent is added continuously so that the temperature inside the reactor is maintained between 55 and 110° C. and the staying time of the mixed mass and the reagent in the reactor is at least 8 minutes. The vapours released in the reaction and containing water vapour and ammonia and its compounds are condensed in the upper part of the reactor and then fed to the flue gas neutralisation system, where they react with ferrous sulphate, producing process water containing precipitate of Mohr salts, which are then fed back to the homogenised mass reacting with quicklime. After the reaction is complete, the sterilised, steaming, and moist semi-finished product at a temperature of 60-70° C. is taken from the reactor outlet to be distributed and dried. The semi-finished product is collected from the reactor outlet by a short, enclosed conveyor belt and fed to a second enclosed conveyor belt, which transports the product to a storage hall or shed, where the semi-finished product is discharged directly to the floor and distributed by a loader, for cooling and drying.

The resulting product has properties that promote plant growth, but it has also unexpectedly been shown to repel pests.

### Experiment 1.

A lawn with a surface area of approximately 400 m2 located outside a single-family building in Warsaw-Ursynow was selected for the study. This lawn was mowed and sectioned into two equal parts. On half of it the repellent according to the invention was evenly distributed, and on the other half the agent was not applied. The lawn was watered generously to dissolve the product. The following day and after 2, 4, and 8 days, snails and slugs were found and counted in both parts. After counting, the snails/slugs were left on the lawn. Table 1 summarises the results.

TABLE 1
Number of snails/slugs found on lawn not
fertilised and fertilised with pest repellent

| | Number of snails/slugs after | | | |
|---|---|---|---|---|
| Lawn | 1 day | 2 days | 4 days | 8 days |
| fertilised with the repellent | 18/10 | 6/5 | 0/0 | 0/0 |
| according to the invention | | | | |
| not fertilised | 22/25 | 27/24 | 29/28 | 23/29 |

Snails and slugs were found on the lawn. The most numerous type of snail was the garden snail (Cepaea hortensis); the grove snail (Cepaea nemoralis) was not numerous. Single snails of the grapevine species (Helix pomatia) were found. Of the slug varieties, the spotted murrelet (Deroceras reticulatum) and the great murrelet (Limax maximus) predominated. These were quite abundant on the lawn, as they thrive in the cool and wet conditions of this year's spring.

After the fertiliser was applied, a sharp decrease in the snail/slug population could be observed in the part fertilised with pest repellent. No snails/slugs were found on the lawn 4 days after repellent was applied. In the non-fertilised part, snails/slugs were abundant throughout the experiment and even became slightly more numerous.

### Experiment 2.

In a home garden in Warsaw, two square flowerbeds (2 m×2 m), each 2 m2 in area, were marked out, in which tulips, Siberian irises, eastern hyacinths and narcissi were growing. Snails/slugs were removed from these flowerbeds. Around one of the beds, 400 g of the repellent according to the invention was spread evenly over an area of 5 m2 (the recommended dosage of 0.8 Uha, i.e. 80 g of agent per 1 m2 was used), thus forming a “protective barrier” for the flowerbed. Around the second bed, no repellent according to the invention was applied. The beds and their surroundings were watered generously to dissolve the product. On the following day and after 2, 4 and 8 days, snails and slugs were found and counted in both parts. After counting, the snails/slugs were left in the bed. Table 2 summarises the results.

Table 2. Number of snails/slugs found in the bed with and without a “protective barrier” provided by the repellent according to the invention

| | Number of shell snails/slugs after | | | |
|---|---|---|---|---|
| Flowerbed | 1 day | 2 days | 4 days | 8 days |
| with a “protective barrier” | 0/0 | 0/0 | 0/0 | 0/0 |
| provided by the repellent | | | | |
| according to the invention | | | | |
| without a “protective | 2/0 | 4/3 | 4/5 | 5/8 |
| barrier” | | | | |

The same snails/slugs were present in and around the beds as on the lawn. The most numerous type of snail was the garden snail (Cepaea hortensis), while the grove snail (Cepaea nemoralis) was sparse. There were also some individual snails of the grapevine species (Helix pomatia). Of the slug varieties, the spotted murrelet (Deroceras reticulatum) and the great murrelet (Limax maximus) predominated.

After the repellent according to the invention was applied, none of the snails/slugs entered the flowerbed through the “protective barrier” provided by the evenly distributed pest repellent. The control bed, around which the repellent had not been spread, was again infested by snails and slugs.

### Conclusions:

The pest repellent effectively repels slugs and snails from crops.

A pest repellent applied to the lawn surface repels shell snails and slugs.

The pest repellent used in the “protective barrier” perfectly protects ornamental plants from harmful snails.

Analogous experiments were carried out for other animals, vertebrates and invertebrates, in particular moles, ants, and mole crickets. These experiments confirmed the analogous efficacy of the product according to the invention against a variety of crop pests

What is claimed is:

1. A means of repelling pests, in particular snails/slugs, moles, ants and mole crickets, characterised in that it is a composition comprising calcium oxide, calcium hydroxide and calcium carbonate, the calcium oxide accounting for not less than 10% by weight of the composition.

2. The pest repellent according to claim 1. characterised in that it is powdered.

3. pest repellent according to claim 2, characterised in that it has the form of granules.

4. The pest repellent according to claim 1 characterised in that it has the form of an aqueous solution of the composition.

5. A method of repelling pests, in particular snails/slugs, moles, ants and mole crickets, characterised in that the pest repellent specified in claim 1 is spread on a ground in the amount of 60-120 g per square metre of a ground surface.

6. The method of repelling pests according to claim 5, characterised in that the surface of the ground is sprayed with water after the pest repellent has been applied.

7. The method of repelling pests according to claim 5, characterised in that the measures are repeated no more than once a week.

8. The method of repelling pests according to claim 6, characterised in that the measures are repeated no more than once a week.

9. A method of repelling pests, in particular snails/slugs, moles, ants and mole crickets, characterised in that the pest repellent specified in claim 2 is spread on a ground in the amount of 60-120 g per square metre of a ground surface.

10. A method of repelling pests, in particular snails/slugs, moles, ants and mole crickets, characterised in that the pest repellent specified in claim 3 is spread on a ground in the amount of 60-120 g per square metre of a ground surface.

11. A method of repelling pests, in particular snails/slugs, moles, ants and mole crickets, characterised in that the pest repellent specified in claim 4 is spread on a ground in the amount of 60-120 g per square metre of a ground surface.

12. The pest repellent according to claim 2, characterised in that it has the form of an aqueous solution of the composition.

13. The pest repellent according to claim 3, characterised in that it has the form of an aqueous solution of the composition.
